(19) United States
(12) Patent Application Publication
(10) Pub. No.: US 2016/0071434 A1
(43) Pub. Date: Mar. 10, 2016

(54) Visual Education Aid for Teaching Stages of a Medical Condition and Methods Therefor

(71) Applicant: Medline Industries, Inc., Mundelein, IL (US)

(72) Inventor: Patricia Turner, Hopatcong, NJ (US)

(21) Appl. No.: 14/480,241

(22) Filed: Sep. 8, 2014

(51) Int. Cl. G09B 23/28; G09B 5/02

(52) U.S. Cl. CPC G09B 23/28; G09B 5/02

(57) ABSTRACT

A visual teaching aid (100) is to assist teaching stages (112,113,114) of a medical condition (111). The visual teaching aid can include a fruit stage portion (103). The fruit stage portion can include a first matrix (105) illustrating a single fruit (106) in a plurality of states (107,108,109). A medical condition portion (104) can then include a second matrix (110) illustrating the medical condition in a plurality of stages. Each state of the single fruit can correspond to a stage of the medical condition on a one-to-one basis.

### BACKGROUND

1. Technical Field

This disclosure relates generally to educational teaching aids, and more particularly to educational teaching aids for medical applications.

2. Background Art

Teachers, professors, and mentors struggle to find new and exciting ways to teach concepts to students. This is especially true in the medical field, where much of what must be learned is by rote memorization. In contrast to geometry or Newtonian physics, where many relationships, formulae, and constructs can be derived from a fundamental set of rules or equations, in the medical field many things must simply be memorized. For example, anatomical parts, medication lists, disease names, etc., must be memorized as large lists. It is challenging to find new ways to teach such information to students in a manner that facilitates retention. It would be advantageous to have an improved teaching aid and methods for medical applications.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory embodiment of a teaching aid in accordance with one or more embodiments of the disclosure.

FIG. 2 illustrates another explanatory embodiment of a teaching aid in accordance with one or more embodiments of the disclosure.

FIG. 3 illustrates one method of using a teaching aid in accordance with one or more embodiments of the disclosure.

FIG. 4 illustrates an explanatory method in accordance with one or more embodiments of the disclosure.

FIG. 5 illustrates yet another explanatory embodiment of a teaching aid in accordance with one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide methods and devices to assist in the training of medical personnel. Embodiments of the disclosure assist health care personnel in understanding the differences between various stages of a medical condition. While a pressure ulcer will be used as an illustrative medical condition for discussion purposes, it should be noted that the visual teaching aids and methods described below can be applied to a wide variety of medical conditions where those conditions progress through a plurality of stages. For example, embodiments of the technique could be used to teach the stages of skin cancer, sunburn, and so forth. Other medical conditions for which embodiments of the disclosure are well suited will be obvious to those of ordinary skill in the art.

Embodiments of the disclosure further provide tools and methods for preparing a health care services provider in identifying the stage of a medical condition. For example, in one embodiment a health care services provider is provided with a visual teaching aid to assist in teaching stages of a medical condition such as the stages of pressure ulcers. To better teach identification of each stage, in one embodiment the visual teaching aid provides a state of a single piece of fruit that is visually representative or characteristically similar to a particular stage of the medical condition. For ease of discussion, an apple will be used as the single piece of fruit. However, other single types of fruit, e.g., a banana, a tomato, a pear, or a peach, could be substituted instead. Similarly, a single vegetable, e.g., an avocado, could be used as well. Still other fruits and vegetables suitable for teaching stages of a medical condition will be obvious to those of ordinary skill in the art having the benefit of this disclosure.

The use of a single type of fruit, e.g., an apple, is advantageous for several reasons. To begin, the comparison in adult learning to a singular item with which the person is familiar is a key factor in the person's ability to conceptualize complex ideas. Accurate conceptualization leads to better retention of those complex ideas. The use of a single type of fruit, e.g., an apple, provides a comparison tool with which nearly everyone is familiar.

Second, the use of a single type of fruit for a single medical condition allows a learner to more easily visualize the stages of the medical condition. Prior art techniques use different types of fruit. However, this creates “which fruit was which stage” confusion. The use of a singular type of fruit, especially if the chronological states of the fruit align with progressing stages of the medical condition, allows a learner to more easily visualize the various stages of the medical condition. The question of “which fruit came first and which came second” is advantageously removed by using a single fruit type. Moreover, when the chronological states of decay of that fruit are correlated with the progression of a medical condition, a learner can more readily visualize how a condition, such as a pressure ulcer, can progress from one stage to another stage, thereby leading to better stage identification retention. Note that it may not always be the case that a medical condition has a definite progression.

Next, it should be noted that when discussing pressure ulcers, embodiments of the disclosure contemplate that the use of an apple as the singular type of fruit is particularly advantageous. This is true because an apple includes all criteria needed to demonstrate pressure ulcer stages, including a red color, a thin skin, and flesh disposed between the skin and the mechanical structure, which is the core. The inventors have discovered that these components can be translated through one or more states that demonstrate the stages of pressure ulcers. Additionally, in one or more embodiments the apple can further be used to demonstrate unstageable conditions due to the fact that learners are also familiar with apples in covered states, such as when covered by caramel or by the red candy that coats a candy apple. Further, in one or more embodiments an apple can be used to teach suspected deep tissue injury by using bruises or “boggy” areas of the apple in certain states.

Embodiments of the disclosure provide a teaching aid that simplifies the understanding of medical condition stage identification. Identifying the stages of a condition, such as a pressure ulcer, is frequently confusing to clinicians. However, the use of a single type of fruit, as noted above, provides an analogous teaching tool that is familiar to many types of learners. Accordingly, the use of an apple as described herein results in pressure ulcers being more readily and accurately identified. This is important because the consequences of misidentifying a pressure ulcer result in an incorrect treatment choice. An incorrect treatment choice only results in the pressure ulcer progressing to more advanced stages. Additionally, misidentifying a pressure ulcer creates serious problems with insurance or Medicare reimbursement. When a pressure ulcer is present when a patient is admitted, it will receive a “higher” diagnosis-related group coding. This results in a higher reimbursement amount to the treatment facility. Proper identification allows the treatment facility to receive adequate reimbursement for the care. By contrast, if the pressure ulcer is not present on admission, but is instead acquired at the treatment facility, the facility would not receive additional funds to care for the condition. It may instead face financial penalties. By using embodiments of the disclosure, health care services providers will be able to more readily identify the stage, select proper treatment regimens and medications, thereby maximizing both the healing process for their patients and reimbursement to cover the cost of care.

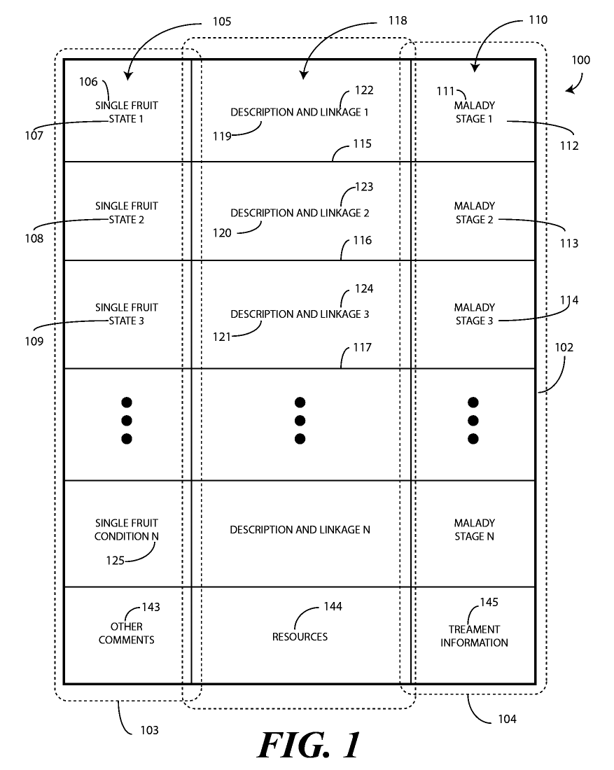

Turning now to FIG. 1, illustrated therein is one embodiment of a visual teaching aid 100 configured in accordance with one or more embodiments of the disclosure. The visual teaching aid 100 is to assist in teaching the stages of a particular medical condition, such as the stages of a pressure ulcer. In this embodiment, the visual teaching aid 100 of FIG. 1 is disposed along a substantially flat substrate 102, such as a piece of paper, poster board, cardboard, card stock, film, laminate, plastic sheeting, or other substantially flat substrate upon which printing can be disposed. In one or more embodiments where the substantially flat substrate 102 is paper-based, the visual teaching aid 100 can be laminated as well.

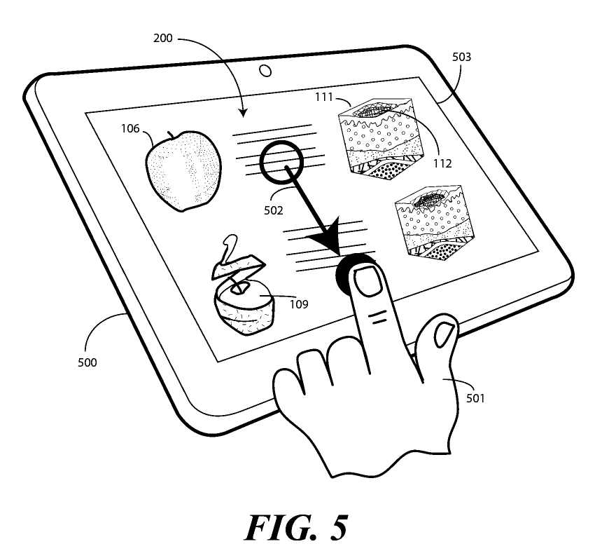

While the substantially flat substrate 102 is singular in the embodiment of FIG. 1, with all information disposed along a single major face of the substantially flat substrate 102, the visual teaching aid 100 could be configured in other ways as well. For example, the visual teaching aid 100 could be configured as a stack of cards, a stack of flash cards, a bi-fold, tri-fold, or multi-fold pamphlet, scroll, or booklet. Additionally, the substantially flat substrate 102 could be a garment, such as a t-shirt or other garment. In one embodiment, the substantially flat substrate 102 is configured as a folio or cover for a tablet computer or palm-top computer. The substantially flat substrate 102 could also be configured as a case for a laptop computer or a medical journal. Still other examples of substantially flat substrates will be obvious to those of ordinary skill in the art having the benefit of this disclosure. For example, as will be shown in FIG. 5 below, the visual teaching aid 100 could be configured for presentation on a tablet or other type of computer as well.

In one embodiment, the visual teaching aid 100 comprises a fruit stage portion 103 and a medical condition portion 104. The fruit stage portion 103 comprises a first matrix 105 illustrating a single fruit 106 in a plurality of states, e.g., state 107, state 108, and state 109. The “single” fruit, as referred to herein, means a single type of fruit, e.g. a red delicious apple. It does not necessarily mean that the fruit shown at each state 107,108,109 is the very same piece. For example, a first red delicious apple may be used to demonstrate state 107, while a second red delicious apple may be used to demonstrate state 108, while a third red delicious apple is used to demonstrate state 108, and so forth.

The medical condition portion 104 comprises a second matrix 110 illustrating a medical condition 111 in a plurality of stages, e.g., stage 112, stage 113, and stage 114. The first stage 112 may be when the medical condition 111 is in its infancy, while the second stage 113 may be a more progressed stage of the medical condition 111. Using skin cancer as an example, the first stage 112 may be when the cancer is initially visible, while the second stage is when the cancer has spread along the user's skin, and so forth. Alternatively, the various stages may correspond to intensity of a medical condition. Using sunburn as an example, the first stage 112 may be light sunburn, while the next stage 113 is a second-degree sunburn, and so forth. Still other stage definitions will be obvious to those of ordinary skill in the art having the benefit of this disclosure.

In one embodiment, each state 108,107,108,109 of the single fruit 106 corresponds to a stage 112,113,114 of the medical condition 111 on a one-to-one basis. Illustrating by example, in this illustrative embodiment the first state 107 of the single fruit 106 corresponds to the first stage 112 of the medical condition 111. Similarly, the second state 108 of the single fruit 106 corresponds to the second stage 113 of the medical condition 111, and so forth. In this illustrative embodiment, the one-to-one correspondence is delineated by divider lines 115,116,117 to make identification of the one-to-one basis relationships easier. However, the one-to-one correspondence can be delineated in other ways as well. For example, the one-to-one correspondence can be identified with colored panels, different font colors, different font types, and so forth. Still other delineation techniques will be obvious to those of ordinary skill in the art having the benefit of this disclosure. In still other embodiments, there may be no additionally delineation other than listing the states 107,108,109 of the single fruit 106 and the stages 112,113,114 of the medical condition 111 so that the one-to-one basis is visibly perceptible to a viewer.

In this illustrative embodiment, the visual teaching aid 100 further includes an optional third matrix 118. The third matrix 118 of this illustrative embodiment includes medical condition information 119,120,121. The medical condition information 119,120,121 can include descriptions of the medical condition 111, instructions on how to identify the various stages 112,113,114 of the medical condition 111, or other information about the medical condition 111. In one embodiment, the third matrix 118 also includes linkage information 122,123,124. The linkage information 122,123,124 can include descriptions explaining how the various states 107,108,109 of the single fruit 106 relate—visually or otherwise—to the various stages 112,113,114 of the medical condition 111. Other linkage information 122,123,124 and other medical condition information 119,120,121 will be obvious to those of ordinary skill in the art having the benefit of this disclosure.

In one embodiment, the medical condition information 119,120,121 and the linkage information 122,123,124 are divided into sub-portions. For example, medical condition information 119 comprises one sub-portion of the sum total of the medical information, while medical information 120 comprises another sub-portion. Similarly, linkage information 122 comprises one sub-portion of the linkage information, while linkage information 123 is another sub-portion, and so forth.

In this illustrative embodiment, as with the states 107,108,109 of the single fruit 106 and the stages 112,113,114 of the medical condition 111, the medical condition information 119,120,121 and the linkage information 122,123,124 each correspond to the states 107,108,109 and the stages 112,113,114 on a one-to-one basis. For example, medical condition information 119 corresponds to the first state 107 and the first stage 112 on a one to one basis. Similarly medical condition information 120 corresponds to the second state 108 and the second stage 113 on a one to one basis, and so forth. Accordingly, in one or more embodiments, each sub-portion of the medical condition information 119,120,121 and/or the linkage information 122,123,124 corresponds to both the stage 112,113,114 of the medical condition 111 and the state 107,108,109 of the single fruit 106 on the one-to-one basis.

In one embodiment, the first matrix 105, the second matrix 110, and the third matrix 118 each comprise a 1×N matrix having one column and N 125 rows. Such is the case in the illustrative embodiment of FIG. 1, where first matrix 105, the second matrix 110, and the third matrix 118 each comprise a 1×N matrix arranged in columns such that the one-to-one basis of the various components is defined by the N 125 rows of the first matrix 105, the second matrix 110, and the third matrix 118.

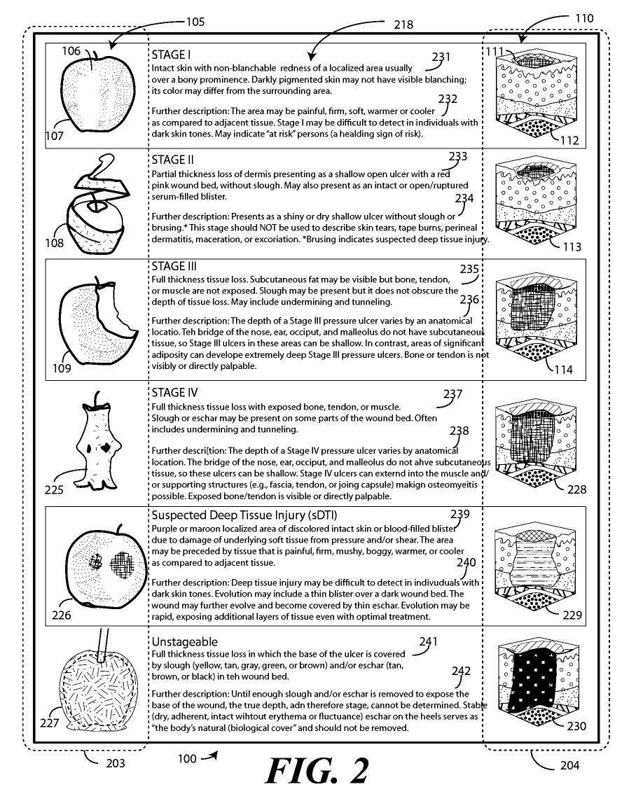

The number of stages 112,113,114 will vary based upon the medical condition 111. For example, some medical conditions will have many stages, while others will have only a few. In this embodiment, the number of stages 112,113,114 is N 125 stages. As will be shown in the discussion of FIG. 2 below, where the medical condition 111 is that of a pressure ulcer, in one embodiment the number of stages comprises at least four stages. Four stages work well because there are four stages of pressure ulcers defined by the National Pressure Ulcers Advisory Panel. However, other numbers of stages can be used as well, even with pressure ulcers. For example, in one embodiment the number of stages comprises six stages: the four stages defined by the National Pressure Ulcers Advisory Panel and two additional stages, namely that of a suspected deep tissue injury condition or a condition that is unstageable. These are shown in FIG. 2 below.

Turning now to FIG. 2, illustrated therein is another visual teaching aid 200 to assist teaching the stages of pressure ulcers. As with the visual teaching aid 100 of FIG. 1, the visual teaching aid of FIG. 2 includes a fruit stage portion 203 and a medical condition portion 204. The fruit stage portion 203 comprises a first matrix 205 illustrating a single fruit 206, which is a red-skinned apple in this embodiment. The red-skinned apple is shown pictorially in a plurality of states, e.g., state 207, state 208, and state 209. The medical condition portion 204 comprises a second matrix 210 illustrating a medical condition 211, which is that of a pressure ulcer. The pressure ulcer is shown pictorially in a plurality of stages, e.g., stage 212, stage 213, stage 214.

In this embodiment, the stages 212,213,124,228,229,230 of the medical condition 211 comprise the following six stages: a first stage (stage 212); a second stage (stage 213); a third stage (stage 214); a fourth stage (stage 228); an unstageable stage (stage 230); and a suspected deep tissue injury stage (stage 229). Stages 212,213,214,228, in this illustrative embodiment, are the four stages defined by the National Pressure Ulcer Advisory Panel. Stage 229 is a suspected deep tissue injury where a purple or maroon localized area of discolored intact skin or blood-filled blister appears due to damage of underlying soft tissue from pressure and/or shear. Where such an injury occurs, the area may be preceded by tissue that is painful, firm, mushy, boggy, warmer or cooler as compared to adjacent tissue. Stage 230 is an unstageable condition, which means that the stage not readily identifiable. Unstageable conditions can result in full thickness tissue loss where the base of the ulcer is covered by slough (yellow, tan, gray, green or brown) and/or eschar (tan, brown or black) in the wound bed.

In this embodiment, the states 207,208,209,225,226,227 of the apple comprise six states: a whole state in which the apple is as if it had just been picked from a tree (state 207); a peeled or partially peeled state (state 208); a partially eaten state in which only a bite or two has been taken from the apple (state 209); an eaten to the core state (state 225); a bruised state (227); and a coated state (state 227). The coated state in this embodiment is the apple being coated in caramel.

These states 207,208,209,225,226,227 of the apple are specifically chosen to correspond to the stages 212,213,214,228,229,230 of the pressure ulcer. For example, the first stage of a pressure ulcer occurs when there is intact skin with non-blanchable redness of a localized area usually over a bony prominence as pictorially shown at stage 212. The term “non-blanchable” refers to a red spot on the skin that is unaffected by pressure. Illustrating by example, if there is a red spot on the skin and a person lightly pushes on it, it can do one of two things. If the skin turns white and the red goes away, this means that the spot is “blanchable” and is not a stage one pressure ulcer. However, if the red does not go away with pressure, it is “non-blanchable” and can represent a stage one pressure ulcer. This corresponds to the red skin of the apple being disposed over the rigid flesh as pictorially shown in the first state 207.

The second stage of a pressure ulcer occurs when partial thickness loss of dermis occurs presenting as a shallow open ulcer with a red pink wound bed, without slough a pictorially shown at stage 213. This loss of dermis corresponds to the loss of the red skin experienced by the apple when it is peeled or partially peeled as pictorially shown at stage 208.

The third stage of a pressure ulcer occurs when there is full thickness tissue loss as pictorially shown at stage 214. Stage three may also include visible subcutaneous fat, but bone, tendon, or muscle is generally not exposed. Slough may be present but it does not obscure the depth of tissue loss. May include undermining and tunneling. This corresponds to the loss of both skin portions and flesh portions of the apple, as pictorially shown at state 209.

The fourth stage of a pressure ulcer occurs when full thickness full thickness tissue loss with exposed bone, tendon or muscle occurs as pictorially shown at stage 228. Slough or eschar may be present on some parts of the wound bed. This stage often includes undermining and tunneling. This corresponds to the apple being fully eaten to the core as pictorially shown at state 226.

As noted above, the suspected deep tissue injury is a condition where purple or maroon localized area of discolored intact skin or blood-filled blister due to damage of underlying soft tissue from pressure and/or shear occurs as pictorially shown at stage 229. The area may be preceded by tissue that is painful, firm, mushy, boggy, warmer or cooler as compared to adjacent tissue. This corresponds to a bruise or other injury to the apple that does not puncture the skin, but leaves a dark pigmented spot, as pictorially shown at state 226.

The unstageable condition occurs when full thickness tissue loss in which the base of the ulcer is covered by slough (yellow, tan, gray, green or brown) and/or eschar (tan, brown or black) in the wound bed as pictorially shown at stage 230. At this condition, the skin above the wound is dead, (i.e., either eschar or slough), and the health care provider cannot tell how deep the wound is until the tissue is removed. Once it is removed, the wound will likely be either a stage three or stage four pressure ulcer. Accordingly, the dead skin prevents its identification, just as a caramel covering over an apple (as pictorially shown at state 227) precludes identification of the condition of an apple.

Thus, as shown and described above, the states 207,208,209,225,226,227 of the apple correspond visually and physically to the stages 212,213,214,228,229,230 of the pressure ulcer. Accordingly, a health care services provider can use the visual teaching aid 200 to quickly and easily retain identification techniques for the stages 212,213,214,228,229,230 of the pressure ulcer.

In this illustrative embodiment, the visual teaching aid 200 further includes a third matrix 218. As with the embodiment of FIG. 1, the third matrix 218 includes medical condition information. In this embodiment, the medical condition information includes both a general medical condition and a more detailed condition description. For example, the general medical condition description 231 for stage one of the pressure ulcer may read: “STAGE 1 Intact skin with non-blanchable redness of a localized area usually over a bony prominence. Darkly pigmented skin may not have visible blanching; its color may differ from the surrounding area. The area may be painful, firm, soft, warmer or cooler as compared to adjacent tissue. Stage I may be difficult to detect in individuals with dark skin tones. May indicate ‘at risk’ persons.’.” The more detailed condition description 232 for the first stage of the pressure ulcer may read: “Further description: The area may be painful, firm, soft, warmer or cooler as compared to adjacent tissue. Stage I may be difficult to detect in individuals with dark skin tones. May indicate ‘at risk’ persons (a heralding sign of risk).”

The other general medical condition description and more detailed condition description information can be similarly formatted. For example, the general medical condition description 233 for stage two of the pressure ulcer may read: “STAGE II Partial thickness loss of dermis presenting as a shallow open ulcer with a red pink wound bed, without slough. May also present as an intact or open/ruptured serum-filled or sero-sanginous filled blister. Presents as a shiny or dry shallow ulcer without slough or bruising*. This stage should not be used to describe skin tears, tape burns, incontinence associated dermatitis, maceration or excoriation. *Bruising indicates deep tissue injury.”

The general medical condition description 235 for stage three of the pressure ulcer may read: “STAGE III Full thickness tissue loss. Subcutaneous fat may be visible but bone, tendon or muscle are not exposed. Slough may be present but does not obscure the depth of tissue loss. May include undermining and tunneling. The depth of a Stage III pressure ulcer varies by anatomical location. The bridge of the nose, ear, occiput and malleolus do not have (adipose) subcutaneous tissue and Stage III ulcers can be shallow. In contrast, areas of significant adiposity can develop extremely deep Stage III pressure ulcers. Bone/tendon is not visible or directly palpable.” The more detailed condition description 236 for the third stage of the pressure ulcer may read: “Further description: The depth of a Stage III pressure ulcer varies by anatomical location. The bridge of the nose, ear, occiput and malleolus do not have subcutaneous tissue, so Stage III ulcers in these areas can be shallow. In contrast, areas of significant adiposity can develop extremely deep Stage III pressure ulcers. Bone/tendon is not visible or directly palpable.”

The general medical condition description 237 for stage four of the pressure ulcer may read: “STAGE IV Full thickness tissue loss with exposed bone, tendon or muscle. Slough or eschar may be present. Often includes undermining and tunneling. The depth of a Stage IV pressure ulcer varies by anatomical location. The bridge of the nose, ear, occiput and malleolus do not have (adipose) subcutaneous tissue and these ulcers can be shallow. Stage IV ulcers can extend into muscle and/or supporting structures (e.g., fascia, tendon or joint capsule) making osteomyelitis or osteitis likely to occur. Exposed bone/muscle is visible or directly palpable.” The more detailed condition description 238 for the fourth stage of the pressure ulcer may read: “Further description: The depth of a Stage IV pressure ulcer varies by anatomical location. The bridge of the nose, ear, occiput and malleolus do not have subcutaneous tissue, so these ulcers can be shallow. Stage IV ulcers can extend into muscle and/or supporting structures (e.g., fascia, tendon or joint capsule) making osteomyelitis possible. Exposed bone/tendon is visible or directly palpable.”

The general medical condition description 239 for stage suspected deep tissue injury may read: “Suspected Deep Tissue Injury (sDTI) Purple or maroon localized area of discolored intact skin or blood-filled blister due to damage of underlying soft tissue from pressure and/or shear. The area may be preceded by tissue that is painful, firm, mushy, boggy, warmer or cooler as compared to adjacent tissue. Deep tissue injury may be difficult to detect in individuals with dark skin tones. Evolution may include a thin blister over a dark wound bed. The wound may further evolve and become covered by thin eschar. Evolution may be rapid exposing additional layers of tissue even with optimal treatment.” The more detailed condition description 240 may read: “Further description: Deep tissue injury may be difficult to detect in individuals with dark skin tones. Evolution may include a thin blister over a dark wound bed. The wound may further evolve and become covered by thin eschar. Evolution may be rapid, exposing additional layers of tissue even with optimal treatment.”

The general medical condition description 241 for the unstageable stage may read: “Unstageable Full thickness tissue loss in which actual depth of the ulcer is completely obscured by slough (yellow, tan, gray, green or brown) and/or eschar (tan, brown or black) in the wound bed. Until enough slough and/or eschar are removed to expose the base of the wound, the true depth cannot be determined; but it will be either a Stage III or IV. Stable (dry, adherent, intact without erythema or fluctuance) eschar on the heels serves as ‘the body's natural (biological) cover’ and should not be removed.” The more detailed condition description 242 may read: “Further description: Until enough slough and/or eschar is removed to expose the base of the wound, the true depth, and therefore stage, cannot be determined. Stable (dry, adherent, intact without erythema or fluctuance) eschar on the heels serves as “the body's natural (biological) cover” and should not be removed.”

While the above paragraphs provide examples of general medical condition descriptions and more detailed condition descriptions, others could be used as well. This is especially true of the medical condition is something other than a pressure ulcer. Accordingly, other examples of general medical condition descriptions and more detailed condition descriptions will be obvious to those of ordinary skill in the art having the benefit of this disclosure.

In one or more embodiments, to draw attention to the general medical condition description initially, the general medical condition description can be set forth in boldfaced type. In one or more embodiments, the more detailed condition description can be set forth in standard type.

Additional information can be included on the visual teaching aid as well. Turning back now to FIG. 1, in one embodiment other comments 143 can be included as well. The other comments 143 can be on the same part of the visual teaching aid 100 as the other components. However, in other embodiments the other comments 143 can be disposed on an attached page for enhanced visibility. The other comments 143 can include background information, a discussion of why the fruit analogy is apropos, a discussion of how and/or why the fruit analogy will work, overview information, additional information about the medical condition, and so forth. To illustrate by example, in one embodiment the additional comments 143 may include background and overview information as set forth the following nine paragraphs:

“How common is it in your facility or in your experience, that despite numerous references, in-services and reviews, some clinicians still struggle with the pressure ulcer staging system? Are the “fruits” of your labor paying off in the educational plan for yourself or for your staff?”

“As adults, our learning styles and patterns tend to be more visual in nature, and adult learning is often solidified by equating concepts to past experiences or ideas that are familiar to us. Malcolm L. Knowles identified six principles of adult learners. Adult learners are internally motivated and self-directed, and they bring life experiences and knowledge to learning. Adult learners are also goal- and relevancy-oriented, as well as practical, and they like to be respected.”

“Since adults bring life experiences and prior knowledge to learning, it is helpful when educators can provide an opportunity to use that existing foundation of knowledge and apply it to their new learning experiences. This reflective learning can also assist the adult learner to examine existing biases or habits based on life experiences and ‘move them toward a new understanding of information presented.’ This visual teaching aid presents a simple analogy anyone can use to help themselves, or staff, really understand the differences between the stages of pressure ulcers.”

“Pressure ulcer staging and CMS: Pressure ulcer staging became particularly important with the passing of the Deficit Reduction Act (DRA). Effective Oct. 1, 2008, payment for pressure ulcers and a list of other high-cost, highly preventable conditions would not be covered if they developed during a patient's hospital stay, coining the phrase, hospital-acquired conditions (HAC). Policy set by the Centers for Medicare and Medicaid Services (CMS) states that the physician or other licensed provider must complete a skin assessment when the patient is admitted to the hospital. This skin assessment must document whether the patient does or does not have pressure ulcers or other skin problems. This documentation is referred to as ‘present on admission,’ or POA. POA indicates that the problem was present when the patient arrived at the facility.”

“Clinicians also assess the patient on admission to determine the risk for developing pressure ulcers. Some patients are at greater risk of pressure ulcers than others for a variety of reasons. Over the course of the patient's hospital stay, frequent, often daily, skin inspections should be conducted. Skin inspections should be performed at every shift in critical care areas such as the intensive care unit (ICU). Overall skin assessments should be performed at regular intervals based on the facility's protocols.”

“The concept of ‘hospital-acquired’ and ‘present on admission’ brought to the forefront the importance of accurate assessment and staging because of the financial implications when pressure ulcers are not accurately staged and assessed on admission. So how can we, as clinicians, help ourselves and our staff get this right?”

“Identifying pressure ulcers: Let's begin with the definition of a pressure ulcer according to the National Pressure Ulcer Advisory Panel (NPUAP): ‘A pressure ulcer is localized injury to the skin and/or underlying tissue usually over a bony prominence, as a result of pressure, or pressure in combination with shear. A number of contributing or confounding factors are also associated with pressure ulcers; the significance of these factors is yet to be elucidated.’”

“Pressure ulcers are described using a staging system. The stages are based on identifying and knowing the levels of skin and tissue involved in each wound. By knowing just how deep each layer goes, we can more easily identify the correct stage. We also need to remember that there are some stages of pressure ulcers where the patient's skin is still intact. These pressure ulcers have certain discolorations associated with them. Now, let's equate the concept of ‘layers’ and ‘colors’ to something we come across maybe almost every day . . . an apple.”

“The old saying is ‘An apple a day keeps the doctor away.’ Well, how about, ‘An apple a day can help take pressure ulcer staging confusion away.’ Let's compare that apple to the NPUAP pressure ulcer staging descriptions using the apple images on the chart that follows.”

In one embodiment, these additional comments 143 can be disposed along a substrate that precedes the visual teaching aid 100. In other embodiments, they can be collocated on a single substrate with the other components of the visual teaching aid.

The additional comments 143 can include linkage information 122,123,124. This linkage information 122,123,124 can include further discussion about the stages 112,113,114 of the medical condition 111 and how they specifically relate to the states 107,108,109 of the fruit. Illustrating by example, linkage information 122,123,124 with reference to pressure ulcers as the medical condition 111 may read as in the following seven paragraphs:

“Stage I: Stage I pressure ulcers are identified as ‘non-blanchable erythema of intact skin.’ Think of the normal state of a delicious red apple. The red color is something that will not go away. We can't ‘touch’ a red apple and make the color be less vibrant or make the color go away. Just like a Stage I pressure ulcer, we can't take away the redness simply by touching it. It will not blanch because there are already signs of capillary compromise within the layers of the skin.”

“Stage II: These pressure ulcers are defined as partial thickness loss of the dermis presenting as a shallow open ulcer. The key here is that there is not a lot of depth to these wounds and that it is right at the layer of the dermis, the inner most layer of skin. Think of apple being peeled. Just the layer of outside ‘skin’ is being removed or impacted when we carefully peel an apple. The same superficial layer has been removed or compromised in a Stage II pressure ulcer. These wounds will not have slough, and they will be superficial in nature.”

“Stage III Pressure ulcers at this stage are full thickness. They involve the underlying subcutaneous tissue. All layers of skin are missing and the wound has greater depth. Think of what your apple looks like when you take a nice healthy bite out of it . . . and the skin is gone, you are into the juicy ‘meat’ of the apple. A Stage III pressure ulcer is similar. It's migrated into the subcutaneous tissue and there is usually depth to these wounds.”

“Stage IV: These pressure ulcers are also full thickness wounds, but the difference from Stage III is that there is underlying structure involved. If you were to bite too far into your apple, you would get to the core . . . to the inner structure of that apple. This is what happens in a Stage IV pressure ulcer. You are down to the inner structure under that subcutaneous layer.”

“Suspected Deep Tissue Injury (sDTI): What if your apple had a purple or dark spot on it. You wouldn't know just how ‘bad’ that apple was underneath that spot. The skin looks intact, but you know that part of that apple is bad and is not good to eat. That's what happens with a suspected deep tissue injury. Just like an apple with a soft discolored spot, a deep tissue injury presents with skin intact, but with a top layer of maroon or purple localized discoloration, letting you know that there is tissue damage underneath even though the skin is intact.”

“Unstageable: Unstageable pressure ulcers are completely covered with eschar or slough, so that the depth of the base of the wound cannot be visualized. Think of a caramel-covered apple. That thick, tannish brown caramel completely coats the apple. Because of that caramel, we don't really know the state of the apple underneath. Just like an unstageable pressure ulcer, because of the slough or eschar obstructing the base of the wound, we don't know how deep it is, and therefore, we cannot stage it, and we consider it unstageable.”

“Although this analogy and comparison is relatively easy, hopefully it will clarify in a simple way, some of the confusion that can be associated with the pressure ulcer stages. You may not ever think of an apple the same way again!”

Still other information can be included as well. For example, in one embodiment a list of resources 144 can be included. The resources 144 can be citations to scholarly articles or other papers, links to websites offering additional information about the medical condition 111, links to websites offering continuing education credit, and so forth. Treatment information 145 can be included as well. While a primary focus of the visual teaching aid 100 is that if stage identification, treatment options can be included as well.

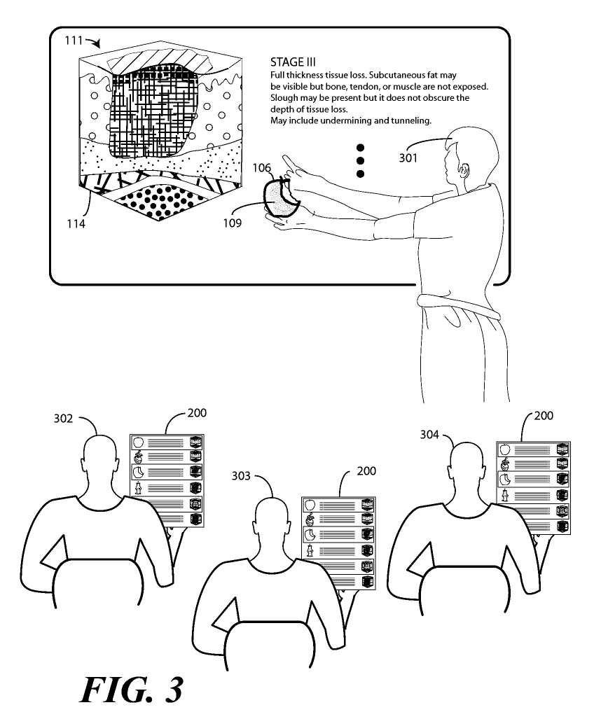

Turning now to FIG. 3, illustrated therein is one explanatory method of using a visual teaching aid 200 in accordance with one or more embodiments of the disclosure. As shown, an instructor 301 is presenting a single fruit 106 to teach stage identification of a medical condition 111. In this embodiment, the single fruit 106 is an actual apple. Embodiments of the disclosure advantageously allow the presentation of the single fruit 106 on visible media, such as a flat substrate or electronic device, or live with the presentation of a real apple. Moreover, starting with a fresh apple, the instructor 301 is able to apply manipulation techniques to the apple to transition it through the various states to teach stage identification of the medical condition 111.

Illustrating by example, the instructor 301 can begin with a fresh apple to teach stage one (as described above with reference to FIG. 2). The instructor 301 can then simply peel some of the apple to teach stage two. As shown in FIG. 3, the instructor 301 can take a few bites from the apple to transform it into the third state 109 to teach the third stage 114 of pressure ulcers. The instructor 301 can then eat the apple to the core to teach the fourth stage of pressure ulcers. Suspected deep tissue injury can be demonstrated by forcibly bruising the apple (prior to eating it to the core). Where sufficient resources, a vat of caramel can be included to teach the unstageable condition. However, in many embodiments a mental visual of this condition is sufficient for teaching purposes.

In one or more embodiments, apples can be passed to the students 302,303,304 as well. This can provide a fun and interactive way to teach stage identification of pressure ulcers (or other maladies), as the students 302,303,304 can manipulate their apples as well. This “hand on” approach to teaching can result in greatly increased retention.

In this embodiment, each student 302,303,304 has been given the visual teaching aid 200 from FIG. 2. Accordingly, as the instructor 301 discusses the stage 114 of the medical condition 111 that is being presented on the wall, and as the instructor 301 manipulates the apple, each student 302,303,304 has pictorial images on a compact, easy to carry and store, visual teaching aid 200. Each student 302,303,304 can then follow along on their visual teaching aid 200 while the instructor 301 presents stage identification information.

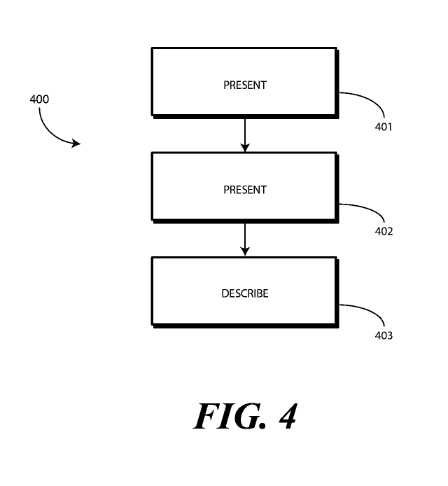

Turning now to FIG. 4, illustrated therein is another explanatory method 400 for teaching the stages of a medical condition. At step 401, the method 400 includes presenting a plurality of states of a single fruit via a medium such that one or more states of the single fruit are visually perceptible to a viewer. As shown in FIG. 1, in one embodiment the medium is a substrate. As shown in FIG. 3, in another embodiment the medium is the presentation of an actual piece of fruit.

In yet another embodiment the presentation can be on the display of an electronic device, as shown in FIG. 5. Turning briefly to FIG. 5, a user 501 is manipulating 502 the touch-sensitive display 503 of an electronic device 500. The visual teaching aid 200 is being presented on the display 503 of the electronic device 500. The user 501 can accordingly scroll through the visual teaching aid 200 at their leisure.

In one or more embodiments, the user 501 can actuate a user actuation target to cause an education module operable in the electronic device 500 to present the visual teaching aid 200. The user 501 may also be able to interact with presentations of the medical condition 111, the single fruit 106, or combinations thereof. For example, the user 501 may be able to click on the second state 109 of the single fruit 106 to watch the apple being peeled, and so forth. Additionally, the user 501 may be able to select a stage 112 of the medical condition 111 to cause an interactive multi-dimensional rendering to appear on the display 503.

Examples of the electronic device 500 include iPod®, iPhone®, or iPad® devices manufactured by Apple Inc., of Cupertino, Calif., cellular telephones or messaging devices such as the Blackberry® manufactured by Research in Motion, Inc., pocket-sized personal computers such as an iPAQ® Pocket PC available by Hewlett Packard Inc., palm-top and tablet style computers running the Android® operating system, such as those manufactured by HTC, Inc., and Motorola, Inc., or any of the other various personal digital assistants, desktop computers, laptop computers, or other electronic devices.

In one or more embodiments, the visual teaching aid 200 can be configured as a downloadable application or “app” suitable for execution on the electronic device 500. The visual teaching aid 200 can be configured as stand-alone software, suitable for storage in any of a number of computer readable media for execution by any number of processing devices.

Turning now back to FIG. 4, at step 402, the method 400 includes presenting a plurality of stages of a medical condition on a display device such that one or more stages of the medical condition are visually perceptible to the viewer. As shown in FIG. 1, in one embodiment the display device is a substrate. As shown in FIG. 3, in another embodiment the display device is a wall or other projection surface upon which images are presented. As will be shown in FIG. 5, in yet another embodiment the display device can be a tablet computer or other electronic device. In one embodiment, the presenting of step 401 and the presenting of step 402 can include presenting each state of the single fruit with a stage of the medical condition on a one to one basis.

At step 403, the method includes describing how each state (107,108,109,225,226,227) of the single fruit (106) resembles each stage (112,113,114,228,229,230) of the medical condition (111). This can include a presentation of the linkage information (122,123,124).

A portion of the disclosure of this patent document contains material to which a claim for copyright is made. The copyright owner has no objection to the facsimile reproduction by anyone of the patent document or the patent disclosure as it appears in the Patent and Trademark Office patent file or records, but reserves all other copyrights whatsoever.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A visual teaching aid to assist teaching stages of a medical condition, the visual teaching aid comprising:
a fruit stage portion, the fruit stage portion comprising a first matrix illustrating a single fruit in a plurality of states; and
a medical condition portion comprising a second matrix illustrating the medical condition in a plurality of stages;
each state of the single fruit corresponds to a stage of the medical condition on a one-to-one basis.

2. The visual teaching aid of claim 1, further comprising a third matrix comprising medical condition information, the medical condition information divided into a plurality of sub-portions, each sub-portion of the medical condition information corresponding to both the stage of the medical condition and the state of the single fruit on the one-to-one basis.

3. The visual teaching aid of claim 2, the first matrix, the second matrix, and the third matrix each comprising a 1×N matrix arranged in columns such that the one-to-one basis is defined N rows of the first matrix, the second matrix, and the third matrix.

4. The visual teaching aid of claim 2, the plurality of stages comprising at least four stages.

5. The visual teaching aid of claim 4, the each sub-portion comprising a general medical condition description and a detailed medical condition description.

6. The visual teaching aid of claim 5, the general medical condition description disposed along the visual teaching aid in boldfaced type, the detailed medical condition description disposed along the visual teaching aid in standard type.

7. The visual teaching aid of claim 4, the medical condition comprising one or more pressure ulcers.

8. The visual teaching aid of claim 7, the single fruit comprising an apple.

9. The visual teaching aid of claim 8, the stages comprising six stages.

10. The visual teaching aid of claim 9, the six stages comprising:
a first stage;
a second stage;
a third stage;
a fourth stage;
an unstageable stage; and
a suspected deep tissue injury stage.

11. The visual teaching aid of claim 8, the plurality of states of the apple comprising:
a whole state;
a peeled state;
a partially eaten state;
an eaten to a core state;
a bruised state; and
a coated state.

12. The visual teaching aid of claim 1, the plurality of stages illustrated pictorially.

13. The visual teaching aid of claim 12, the plurality of states illustrated pictorially.

14. The visual teaching aid of claim 13, the plurality of stages and the plurality of states disposed along a substantially flat substrate.

15. The visual teaching aid of claim 13, the visual teaching aid presented on a display of an electronic device.

16. A method of teaching stages of a medical condition, the method comprising:
presenting a plurality of states of a single fruit via a medium such that one or more states of the single fruit are visually perceptible to a viewer; and
presenting a plurality of stages of the medical condition on a display device such that one or more stages of the medical condition are visually perceptible to the viewer;
the presenting comprising presenting each state of the single fruit with a stage of the medical condition on a one to one basis.

17. The method of claim 16, the medium comprising the display device.

18. The method of claim 17, the display device comprising a substantially flat substrate.

19. The method of claim 16, the medium comprising an actual piece of the single fruit.

20. The method of claim 16, further comprising describing how each state of the single fruit resembles each stage of the medical condition.
